(19) United States
(12) Patent Application Publication
(10) Pub. No.: US 2026/0274108 A1
(43) Pub. Date: Sep. 17, 2026

(54) Electric Commercial Vehicles Comprising Split Cooling Systems and Methods of Servicing Such Vehicles

(71) Applicant: Harbinger Motors Inc., Garden Grove, CA (US)

(72) Inventors: Kartikay Goel, Long Beach, CA (US); Phillip John Weicker, Hermosa Beach, CA (US); Cody Rhebergen, Gardena, CA (US); Phil Gow, Ruby, NY (US)

(21) Appl. No.: 19/079,811

(22) Filed: Mar. 14, 2025

(51) Int. Cl. B60L 53/80; B60K 11/04; B60K 11/08; B60L 50/60; B60L 58/26; B62D 21/03; H01M 10/613; H01M 10/625; H01M 10/6568

(52) U.S. Cl. CPC B60L 53/80; B60K 11/04; B60K 11/08; B60L 50/66; B60L 58/26; B62D 21/03; H01M 10/613; H01M 10/625; H01M 10/6568; H01M 2220/20

(57) ABSTRACT

Described herein are electric commercial vehicles and methods of servicing such vehicles. In some examples, an electric commercial vehicle comprises a body having a grill, a vehicle frame having frame rails, one battery pack positioned between the frame rails and proximate to the grill, and another battery pack stacked vertically with the first battery pack and also proximate to the grill, and a cooling system with two cooling modules and an airflow splitter. Both cooling modules are offset relative to the grill along at least the width direction. The airflow splitter is configured to split an inflow from the grill into two outflows, one for each cooling module. This vehicle configuration allows both battery packs to be serviced (e.g., removed from the vehicle) without breaking any fluidic couplings to the cooling modules.

### BACKGROUND

Both internal combustion engine (ICE) vehicles and electric vehicles need cooling systems to dissipate heat to the environment. For example, ICE vehicles generate heat during combustion cycles, while electric vehicles generate heat during battery charging/discharging as well as during the operation of power electronics and electric motors. Furthermore, both types of vehicles may use their cooling systems to provide passenger comfort and even cargo cooling.

At the same time, commercial vehicles generate substantial amounts of heat during their operation. For example, a Class 4-6 vehicle may need to dissipate 10-50 kW (depending on the operating conditions), which may require a large radiator. ICE vehicles are typically able to fit such radiators over the frame and in front of the engine (due to the relatively small size of the engine). In electric vehicles, such as step vans, the front part (e.g., within the frame and over the frame) is a desirable location for positioning battery packs. As such, space may not be available for cooling systems.

What is needed are new types of cooling systems that do not interfere with the battery packs positioned in the front of the vehicle and supported by the frame.

### SUMMARY

Described herein are electric commercial vehicles (e.g., step vans) and methods of servicing such vehicles. In some examples, an electric commercial vehicle comprises a body having a grill, a vehicle frame having frame rails, one battery pack positioned between the frame rails and proximate to the grill, and another battery pack stacked vertically with the first battery pack and also proximate to the grill, and a cooling system with two cooling modules and an airflow splitter. Both cooling modules are offset relative to the grill along at least the width direction. The airflow splitter is configured to split an inflow from the grill into two outflows, one for each cooling module. This vehicle configuration allows both battery packs to be serviced (e.g., removed from the electric commercial vehicle) without breaking any fluidic couplings to the cooling modules.

Clause 1. An electric commercial vehicle comprising: a vehicle body comprising a grill and defining a length direction, a width direction perpendicular to the length direction, and a height direction perpendicular to each of the length direction and the width direction; a vehicle frame comprising a first frame rail and a second frame rail extending along the length direction and forming an open frame cavity between the first frame rail and the second frame rail; a first battery pack positioned at least in part within the open frame cavity between the first frame rail and the second frame rail; a second battery pack stacked with the first battery pack along height direction and extending at least in part outside of the open frame cavity; a cooling system comprising a first cooling module, a second cooling module, and an airflow splitter, wherein: each of the vehicle frame, the first battery pack, the second battery pack extends at least in part between the first cooling module and the second cooling module, and the airflow splitter is configured to split an inflow received from the grill into a first outflow and a second outflow such that the first outflow is directed to the first cooling module while the second outflow is directed to the second cooling module, and each of the first cooling module and the second cooling module comprises at least a liquid-cooling radiator.

Clause 2. The electric commercial vehicle of clause 1, wherein each of the first cooling module and the second cooling module is offset relative to the grill along the width direction.

Clause 3. The electric commercial vehicle of clause 1, wherein: the airflow splitter comprises a first side duct, a second side duct, and a center portion positioned between the first side duct and the second side duct, the center portion is aligned with the grill and is configured to split the inflow received from the grill into the first outflow and the second outflow, the first side duct is connected to the first cooling module and is configured to direct the first outflow to the first cooling module, and the second side duct is connected to the second cooling module and is configured to direct the second outflow to the second cooling module.

Clause 4. The electric commercial vehicle of clause 3, wherein the center portion overlaps with each of the first side duct and the second side duct.

Clause 5. The electric commercial vehicle of clause 3, wherein each of the center portion, the first side duct, and the second side duct is independently attached to the vehicle frame.

Clause 6. The electric commercial vehicle of clause 3, wherein: each of the first side duct and the second side duct comprises an inlet opening and an outlet opening, and the outlet opening has a larger area than the inlet opening.

Clause 7. The electric commercial vehicle of clause 6, wherein a center of the inlet opening is offset relative to a center of the outlet opening along at least one of the width direction and the height direction.

Clause 8. The electric commercial vehicle of clause 7, wherein the center of the inlet opening is offset relative to the center of the outlet opening along both the width direction and the height direction.

Clause 9. The electric commercial vehicle of clause 6, wherein the inlet opening is not parallel to the outlet opening.

Clause 10. The electric commercial vehicle of clause 6, wherein each of the inlet opening and the outlet opening is not parallel to a plane defined by the width direction and the height direction.

Clause 11. The electric commercial vehicle of clause 6, wherein a projection of each of the inlet opening and the outlet opening does not overlap with a projection of the grill onto a plane defined by the width direction and the height direction.

Clause 12. The electric commercial vehicle of clause 3, wherein: the vehicle frame further comprises a front cross-member, interconnecting the first frame rail and the second frame rail such that the front cross-member extends the width direction, and the center portion is non-planar and conforms around a front top cross-member positioned above the front cross-member and supported using the first frame rail and the second frame rail.

Clause 13. The electric commercial vehicle of clause 12, wherein each of the front cross-member, the front top cross-member, the first battery pack, and the second battery pack is removable from the electric commercial vehicle without removal of either one of the first cooling module and the second cooling module.

Clause 14. The electric commercial vehicle of clause 12, wherein each of the front cross-member, the front top cross-member, the first battery pack, and the second battery pack is removable from the electric commercial vehicle without removal of either one the first side duct and second side duct.

Clause 15. The electric commercial vehicle of clause 1, wherein each of the first cooling module and the second cooling module further comprises a refrigerant heat-exchanger.

Clause 16. The electric commercial vehicle of clause 15, wherein: the cooling system is further comprising a central thermal unit fluidically connected to each of the first battery pack, the second battery pack, the liquid-cooling radiator and the refrigerant heat-exchanger of the first cooling module, and the liquid-cooling radiator and the refrigerant heat-exchanger of the second cooling module, and the central thermal unit is configured to control temperature of each of the first battery pack, and the second battery pack.

Clause 17. The electric commercial vehicle of clause 1, wherein each of the first cooling module and the second cooling module further comprises a set of fans offset relative to each other along the height direction.

Clause 18. The electric commercial vehicle of clause 1, wherein each of the first cooling module and the second cooling module further comprises an electronic expansion valve.

Clause 19. The electric commercial vehicle of clause 1, wherein the liquid-cooling radiator of the first cooling module is fluidically connected in parallel with the liquid-cooling radiator of the second cooling module.

Clause 20. A method of servicing an electric commercial vehicle, the method comprising: providing the electric commercial vehicle comprising a vehicle frame, a first battery pack, and a cooling system, wherein: the vehicle frame comprises a first frame rail, a second frame rail, a front cross-member attached to and supporting at least in part the first battery pack, and a front top cross-member attached to and supporting at least in part the second battery pack, and the cooling system comprising a first cooling module, a second cooling module, and an airflow splitter comprising a first side duct, a second side duct, and a center portion positioned between the first side duct and the second side duct, and each of the vehicle frame, the first battery pack, and the second battery pack extends at least in part between the first cooling module and the second cooling module; positioning the grill away from the front cross-member; disconnecting the center portion from the vehicle frame; disconnecting the front cross-member from each of the first frame rail and the second frame rail; and disconnecting the first battery pack from each of the first frame rail and the second frame rail and removing the first battery pack from the electric commercial vehicle, wherein each of the first cooling module and the second cooling module remain fluidically connected to a remaining portion of the cooling system while the first battery pack is being removed from the electric commercial vehicle.

These and other embodiments are described further below with reference to the figures.

### BRIEF DESCRIPTION OF THE DRAWINGS

FIG. 1A is a schematic side view of an electric commercial vehicle, in accordance with some examples.

FIG. 1B includes a schematic side view and a front view of another example of the electric commercial vehicle.

FIG. 1C is a schematic front view of a portion of the electric commercial vehicle in FIG. 1A, in accordance with some examples.

FIG. 1D is a schematic front view of a portion of the electric commercial vehicle in FIG. 1A (with the body not shown) to illustrate the grill position relative to the airflow splitter and both cooling modules, in accordance with some examples.

FIG. 1E is a schematic side view of the front portion of the electric commercial vehicle in FIG. 1A to illustrate the position of a cooling module and frame components, in accordance with some examples.

FIG. 1F is a schematic side view of the front portion of the electric commercial vehicle in FIG. 1C (with the body not shown) to illustrate the position of the cooling module, battery packs, and frame components in accordance with some examples.

FIG. 2A is a block diagram of an electric commercial vehicle illustrating various components of the vehicle, in accordance with some examples.

FIG. 2B is a perspective view of the frame and cooling system of an electric commercial vehicle, in accordance with some examples.

FIG. 2C is a front view of the electric commercial vehicle (without an airflow splitter) illustrating the frame, battery packs, and cooling system components, in accordance with some examples.

FIGS. 2D and 2E are perspective and front views of the front portion of the electric commercial vehicle illustrating the airflow splitter, in accordance with some examples.

FIGS. 3A and 3B and schematic perspective and front views of an airflow splitter, in accordance with some examples.

FIG. 3C is a schematic front view of another example of the airflow splitter.

FIGS. 3D-3F are different cross-sectional views of the airflow splitter in FIG. 3C.

FIGS. 4A and 4B are two perspective views of the cooling module, in accordance with some examples.

FIG. 5 is a process flowchart corresponding to a method of servicing battery packs on an electric commercial vehicle, in accordance with some examples.

### DETAILED DESCRIPTION

In the following description, numerous specific details are outlined to provide a thorough understanding of the presented concepts. The presented concepts may be practiced without some or all these specific details. In other instances, well-known process operations have not been described in detail to not unnecessarily obscure the concepts described. While some concepts will be described in conjunction with the specific embodiments, it will be understood that these embodiments are not intended to be limiting.

### Introduction

As noted above, electric vehicles and, in particular, commercial electric vehicles carrying cargo (such as electric step vans) need to locate battery packs, preferably at the front of these vehicles (for weight distribution). Unlike passenger vehicles, which use a single battery pack, a multiple-battery-pack configuration is more appropriate for commercial electric vehicles. Specifically, the multiple-battery-pack configuration provides multiple range/weight/cost options as well as simplifies serviceability/replacement of the battery packs. Furthermore, commercial electric vehicles are designed to carry substantial weight, which allows using the multiple-battery-pack configuration for weight distribution. In particular, there are significant weight-distribution benefits for positioning battery packs in the front of the electric commercial vehicle. However, the front of the vehicle has various other systems (e.g., steering, suspension, cooling) in addition to the vehicle frame that limits the space available for batteries. Furthermore, access to the batteries (for service) is important, preferably without the need to remove/disassemble other systems. All such considerations present significant challenges to the front placement of battery packs.

A step van (also known as a walk-in van) is a specific type of vehicle that can be defined as a Class 4-6 commercial vehicle (based on the gross vehicle weight rating of about 16,000-26,000 lbs or about 7,000-12,000 kg). A step van features a walk-in cargo area and a driver's cab that is easy to step in and out of and can be used for various delivery and service applications. The electrification of a step van requires a significant amount of battery capacity (e.g., at least 60-100 kWh) to provide sufficient operating range (e.g., at least 100 kilometers). To achieve this battery capacity, multiple battery packs need to be positioned along the vehicle's frame, especially at the front of the vehicle to achieve uniform weight distribution (e.g., when the step van is loaded with cargo).

While figures and various parts of the description may refer to electric step vans as specific examples of electric commercial vehicles, other types of vehicles are also within the scope, e.g., box trucks, recreation vehicles (RVs), tow trucks, dump trucks, utility and service trucks, ambulances/emergency vehicles, shuttle busses/passenger vans, refrigerated trucks (reefers), and the like.

For example, if the vehicle front above the vehicle frame is occupied by a battery pack, this space becomes unavailable for a cooling system. At the same time, the cooling system is preferably positioned at the front of the vehicle to take advantage of the incoming airflow when the vehicle is moving (i.e., the airflow targets for cooling needs). However, positioning the cooling system in the front of the vehicle frame can significantly increase the vehicle length, undesirable from the vehicle safety perspective, and the vehicle's ability to maintain its operability after a minor front collision.

Described herein is an electric vehicle equipped with a split cooling system comprising two separate cooling modules. These two cooling modules are positioned such that the vehicle frame protrudes between these modules. In other words, the two cooling modules are positioned on the sides of the frame with the frame defining the length of the vehicle. As such, the split cooling system allows to efficiently package two cooling modules in the front of the vehicle (one on each side of the frame) without making the chassis longer, while meeting airflow targets. Furthermore, this split cooling system eliminates the need to change a conventional single-center grill configuration (e.g., commonly used on ICE vehicles). As such, conventional vehicle bodies can be utilized with such split cooling systems without a need for any or at least significant modifications. Finally, the split cooling design allows using more contoured hood designs.

A split cooling system is configured for an electric commercial vehicle comprising a frame and a battery pack positioned in the vehicle front over the frame. As such, the space above the frame is not available, while positioning parts of the cooling in front of the frame increases the vehicle length. A cooling system comprises two radiators positioned on the side of the frame such that the frame (and one or more battery packs supported by the frame) are positioned between the two cooling modules.

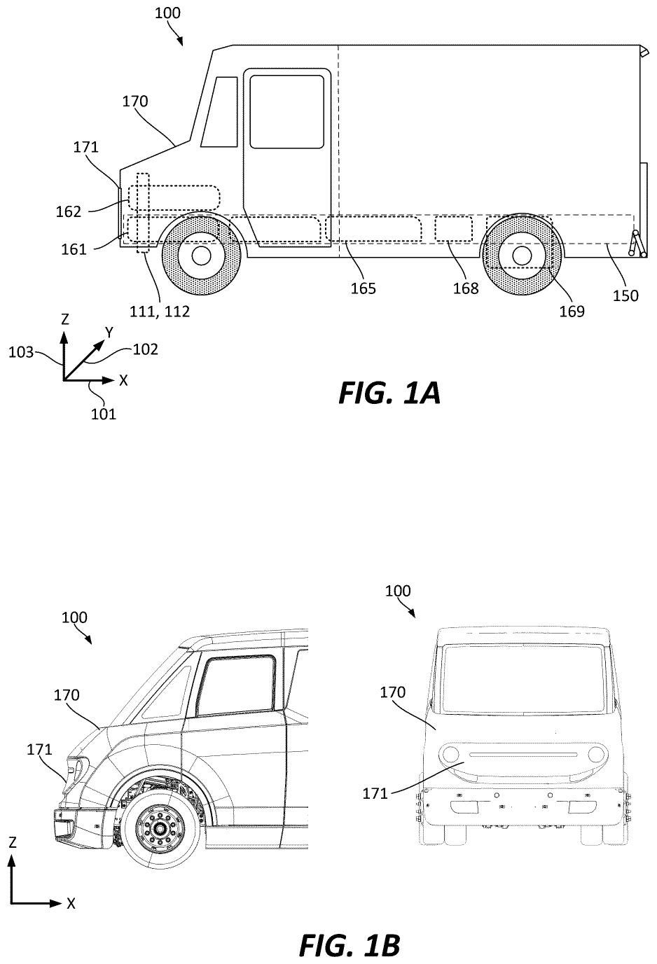

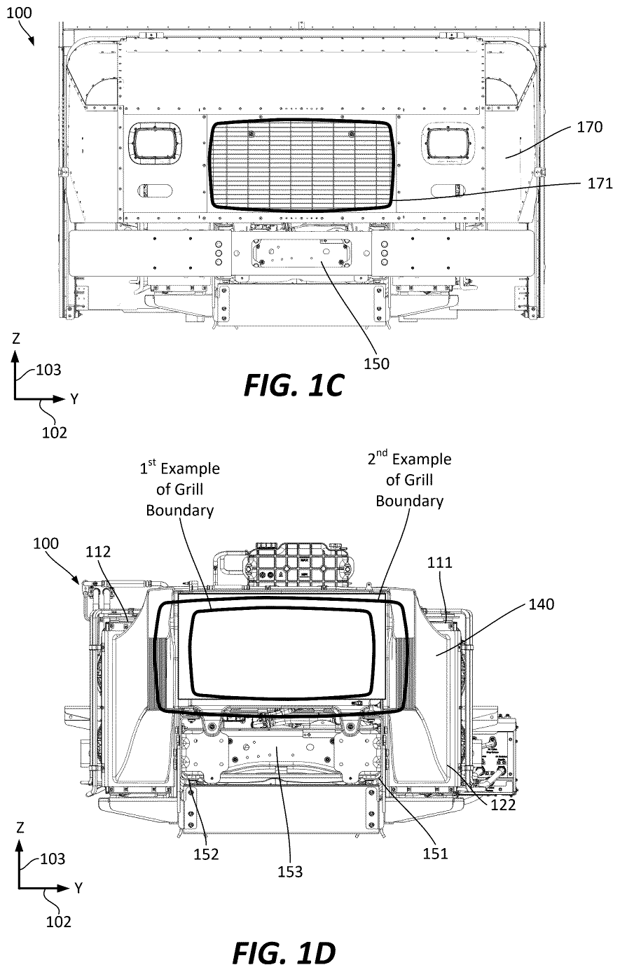

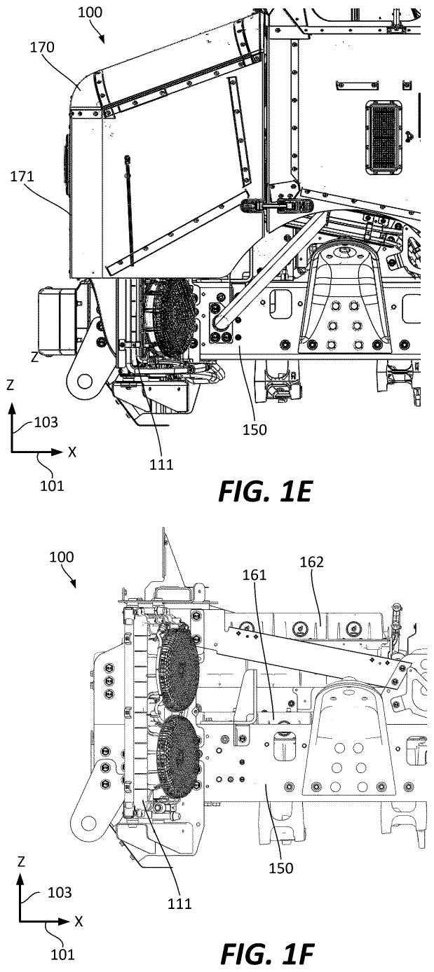

This split cooling system utilizes an airflow splitter comprising a first side duct, a second side duct, and a center portion positioned between and interconnecting the first side duct and the second side duct. The center portion is aligned with the grill and is configured to split the inflow received from the grill into the first outflow and the second outflow. The first side duct is connected to the first cooling module and is configured to direct the first outflow to the first cooling module, which is positioned on the side of the frame. The second side duct is connected to the second cooling module and is configured to direct the second outflow to the second cooling module, which is also positioned on the side of the frame. In other words, the frame is positioned between the two cooling modules. This configuration can be used with various types of electric commercial vehicles that typically have a central position on the grill, e.g., as shown in FIGS. 1A-1E.

FIG. 1A is a schematic side view of an electric commercial vehicle 100 comprising a vehicle body 170 and a grill 171 providing airflow to a first cooling module 111 and a second cooling module 112. The electric commercial vehicle 100 also comprises a vehicle frame 150 protruding along the length direction 101 (X-axis) and supporting various systems of the electric commercial vehicle 100, such as a first battery pack 161 and second battery pack 162 positioned at the front of the electric commercial vehicle 100 (e.g., next to the grill 171) for weight distribution. Notably, at the front of the electric commercial vehicle 100, the vehicle frame 150 protrudes past the first cooling module 111 and second cooling module 112 such that these cooling modules are positioned on the sides of the frame (with the frame extending between these cooling modules).

The electric commercial vehicle 100 may include additional battery packs 165, positioned within the vehicle frame 150 and offset relative to the first battery pack 161 toward the back of the electric commercial vehicle 100. Various other systems, e.g., power electronics 168 and drive unit 169 may be supported in the vehicle frame 150 and, in some examples, connected to a cooling system.

It should be noted that different electric commercial vehicles may have different hood shapes, which changes the space available for the cooling system components and battery packs. FIG. 1B includes a schematic side view and a front view of another example of the electric commercial vehicle 100. This example has a different hood shape, potentially providing even less space in the front for accommodating various systems, e.g., battery packs, cooling system components, suspension components, steering components, and the like. Furthermore, this example has a different size/shape of grill 171 than in the example of FIG. 1C. The two grill shapes/sizes relative to the airflow splitter 140 and in particular to the inlet openings leading to each cooling module are shown in FIG. 1D. In the first example, the grill boundary (which may be representative of grill 171 in FIG. 1C) is smaller and does not overlap with either inlet opening. The center portion of the airflow splitter 140 is relied on to redirect the ram air into these inlet openings. In the second example, the grill boundary (which may be representative of grill 171 in FIG. 1B) is larger and overlaps with both inlet openings resulting in some ram air going directly into these inlet openings. In other examples, a grill 171 may have multiple openings, e.g., each specifically aligned with a corresponding inlet opening. In this multi-grill example, the center portion of the airflow splitter may not be needed.

FIG. 1E is a schematic side view of the front portion of the electric commercial vehicle 100 in FIG. 1A to illustrate the position of a cooling module and frame components, e.g., relative to the grill 171 and other parts of the vehicle body 170. FIG. 1F is a schematic side view of the front portion of the electric commercial vehicle in FIG. 1C (with the body not shown) to illustrate the position of the cooling module, battery packs, and frame components in accordance with some examples.

Overall, this configuration allows positioning two battery packs close to the front of the vehicle (e.g., effectively behind the grill) and servicing these front-mounted battery packs without breaking fluid connections to the cooling modules. It should be noted that the battery packs may be liquid-cooled, i.e., also parts of the cooling system. Therefore, fluid connections to the battery packs may be severed when removing the battery packs from the electric commercial vehicle.

### Examples of Electric Commercial Vehicles

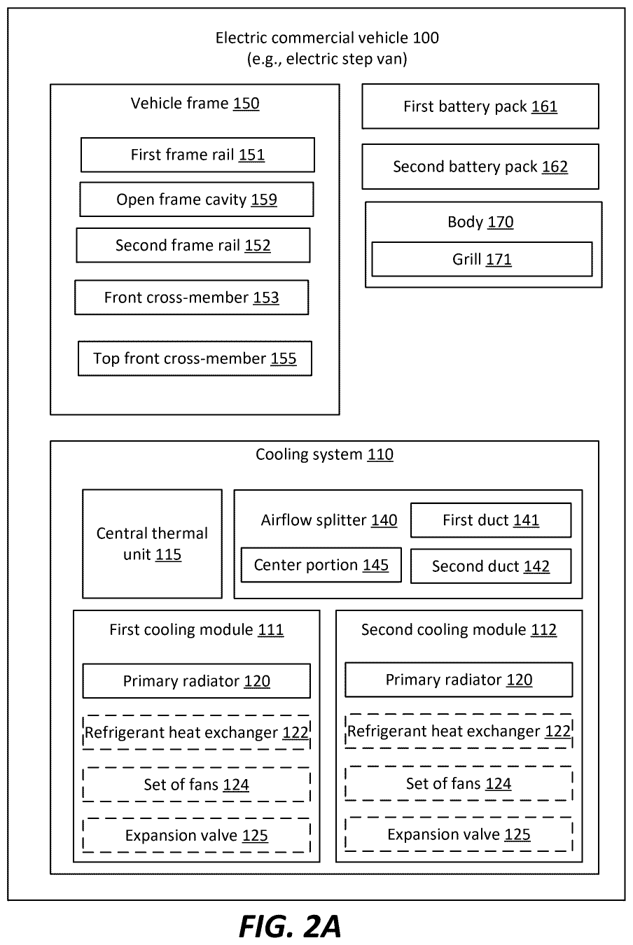

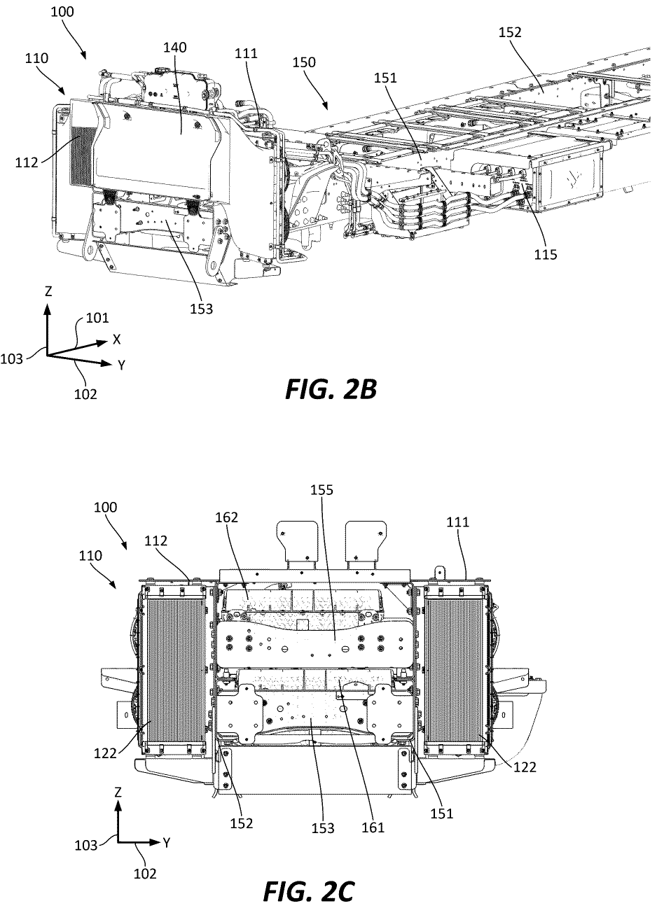

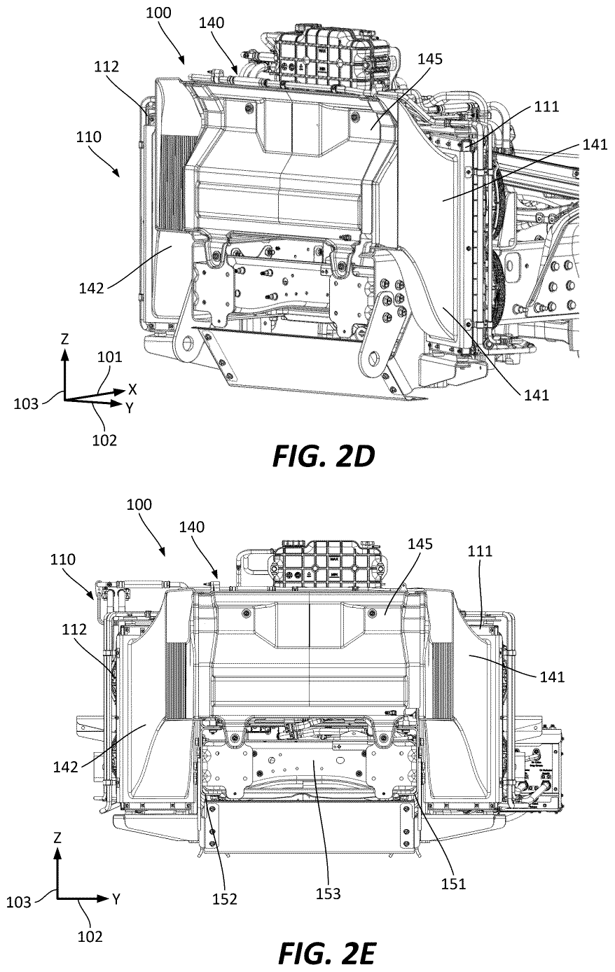

FIG. 2A is a block diagram of an electric commercial vehicle 100 illustrating various components of the electric commercial vehicle 100, in accordance with some examples. As stated above, an electric commercial vehicle 100 comprises a vehicle body 170 comprising a grill 171. The vehicle body 170 defines a length direction 101 (corresponding to an X-axis in various figures), a width direction 102 (corresponding to a Y-axis in various figures) perpendicular to the length direction 101, and a height direction 103 (corresponding to an X-axis in various figures) perpendicular to each of the length direction 101 and the width direction 102. These directions are needed to define the orientations of various vehicle components.

Furthermore, as noted above, an electric commercial vehicle 100 comprises a vehicle frame 150 having a first frame rail 151, a second frame rail 152, and a front cross-member 153. Each of the first frame rail 151 and the second frame rail 152 extends along the length direction 101 and forms an open frame cavity 159 between the first frame rail 151 and the second frame rail 152. The open frame cavity 159 is positioned proximate to the front cross-member 153. In fact, the open frame cavity 159 may be defined by the front cross-member 153 (in addition to another cross-member and both the first frame rail 151 and the second frame rail 152). As such, the open frame cavity 159 may be also referred to as a front frame cavity to distinguish from other cavities positioned between the first frame rail 151 and the second frame rail 152. In some examples, the front cross-member 153 (and/or the front portions between the first frame rail 151 and the second frame rail 152) may be used to attach a front bumper of the electric commercial vehicle 100. In the same or other examples, the grill 171 is positioned less than 200 millimeters or even less than 100 millimeters to the frontmost frame member (e.g., front cross-member 153 and/or front top cross-member 155). As such, very limited space is available between the vehicle frame 150 and the grill 171, e.g., for positioning an airflow splitter 140. Other components of the cooling system 110 (e.g., a first cooling module 111 and/or a second cooling module 112) may not be able to fit into this space. In the same or other examples, the grill 171 is positioned less than 100 millimeters or even less than 50 millimeters from the airflow splitter 140.

The electric commercial vehicle 100 also comprises a set of battery packs comprising a first battery pack 161 and a second battery pack 162. In some examples, additional battery packs are provided and positioned, e.g., between the first frame rail 151 and the second frame rail 152. Each battery pack may have an energy capacity of 20-50 kWh or, more specifically, 30-40 kWh, such as about 35 kWh. The weight of each battery pack can be 100-300 kg or, more specifically, 150-250 kg. The length of each battery pack can be 0.5-1.5 meters or, more specifically, 0.8-1.2 meters. The width of each battery pack can be 0.4-1.2 meters or, more specifically, 0.5-0.9 meters. This dimension ensures that each battery pack may fit between the first frame rail 151 and the second frame rail 152. The height of each battery pack can be 0.1-1.4 meters or, more specifically, 0.2-0.3 meters (to ensure that the battery pack is generally within the boundary of the vehicle frame 150 when placed between the first frame rail 151 and the second frame rail 152). In some examples, all battery packs have the same configuration and, therefore, are interchangeable.

Referring to FIG. 2C, the first battery pack 161 may be positioned at least in part within the open frame cavity 159 between the first frame rail 151 and the second frame rail 152, e.g., proximate to the front cross-member 153. As such, the first battery pack 161 may be referred to as a front-most in-frame battery pack. The first battery pack 161 may be attached to the front cross-member 153 and another cross-member, spaced away from the front cross-member 153 towards the end of the vehicle and forming the open frame cavity 159 together with the front cross-member 153 as well as the first frame rail 151 and the second frame rail 152. In specific examples, all battery packs are connected to the frame's cross-members. It should be noted that some cross-members may be connected directly to the first frame rail 151 and the second frame rail 152, while other cross-members (e.g., front top cross-member 155) may be positioned above the plane defined by the first frame rail 151 and the second frame rail 152 and may be connected to the first frame rail 151 and the second frame rail 152 by additional frame components (e.g., side brackets). The attachment of the battery packs to the cross-members provides simpler access and removal of the battery packs. Finally, it should be noted that some battery packs (not the first battery pack 161 or the second battery pack 162) may be removed from the electric commercial vehicle 100 without removing any cross-members. Considering that the first battery pack 161 or the second battery pack 162 are positioned at the front of the electric commercial vehicle 100, which also houses the front suspension, steering, and other systems and is restricted by the hood contour, the removal of the front cross-members of the frame 150 may be needed during the removal of the first battery pack 161 and/or the second battery pack 162.

Referring to FIG. 2C, the second battery pack 162 is stacked with the first battery pack 161 along height direction 103 (i.e., above the first battery pack 161). As such, the second battery pack 162 extends at least in part outside of the open frame cavity 159. In some examples, the entire volume of the second battery pack 162 is positioned outside of the open frame cavity 159 (extends above the plane defined by the top surfaces of the first frame rail 151 and the second frame rail 152). In other words, the second battery pack 162 may be positioned above the first frame rail 151 and the second frame rail 152. The second battery pack 162 is also attached to a front cross-member (which may be referred to as a front top cross-member 155 to differentiate from the front cross-member 153 supporting the first battery pack 161) and another top cross-member offset relative to the front top cross-member 155 toward the end of the electric commercial vehicle 100. Both top cross-members may be attached to the first frame rail 151 and the second frame rail 152 by the side supports.

Referring to FIGS. 2A-2E, the cooling system 110 comprises a first cooling module 111 and a second cooling module 112. Each of the first cooling module 111 and the second cooling module 112 may comprise at least a liquid-cooling radiator 120. In some examples, each of the first cooling module 111 and the second cooling module 112 may comprise a refrigerant heat exchanger, enabling various additional functionality of the cooling system 110. As such, the first cooling module 111 and the second cooling module 112 may be also referred to as heat-exchanging modules. Various additional examples of these modules are described below.

Referring to FIGS. 2B, 2D, and 2E, the cooling system 110 also comprises an airflow splitter 140, which is configured to split an inflow received from the grill 171 into a first outflow and a second outflow such that the first outflow is directed to the first cooling module 111 while the second outflow is directed to the second cooling module 112. Additional details of these airflow splitter 140 are also described below.

### Examples of Airflow Splitters

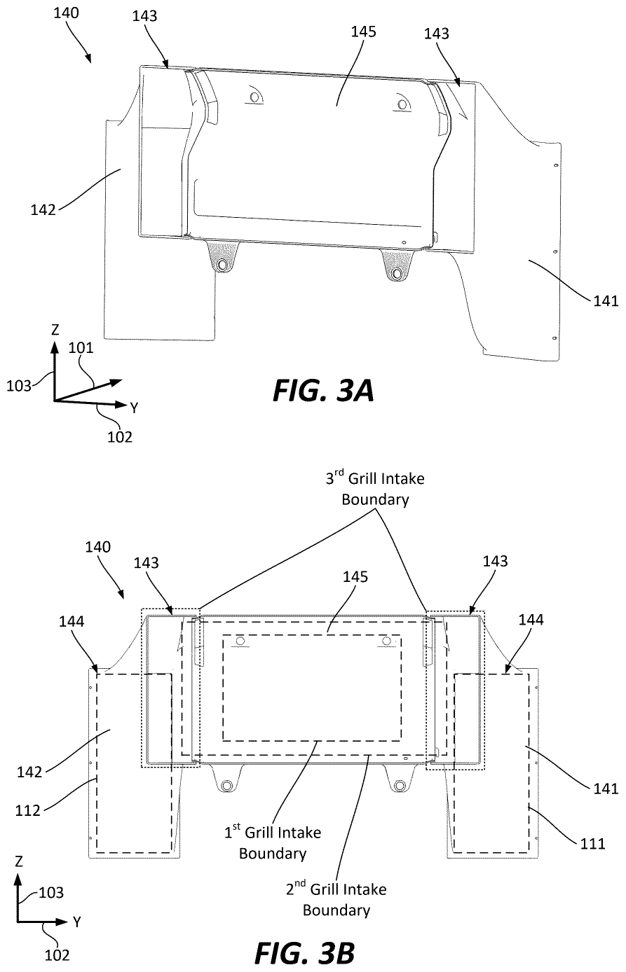

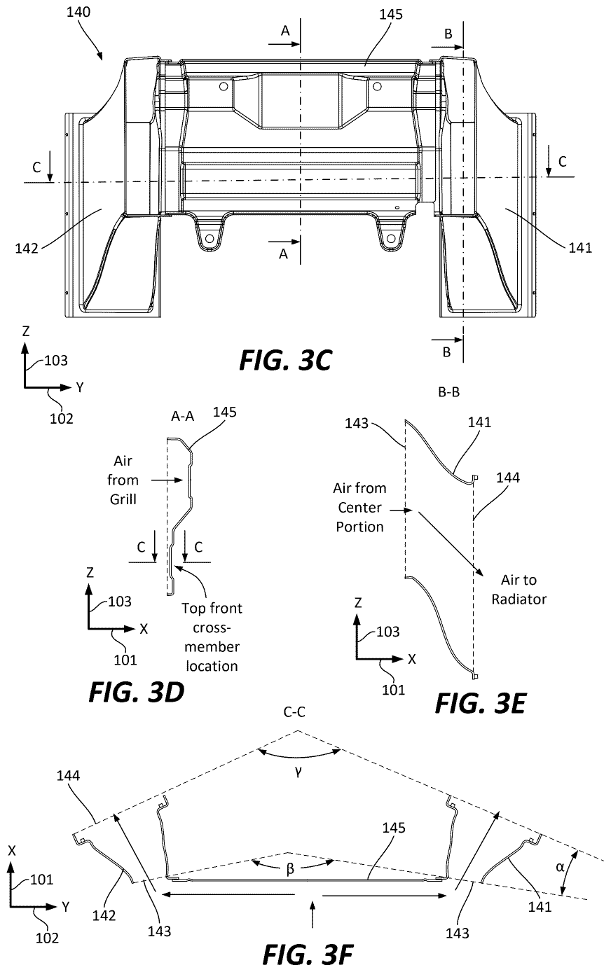

FIG. 3A is a schematic perspective view of the airflow splitter 140, while FIG. 3B is a corresponding front view, in accordance with some examples. Furthermore, FIG. 3C is a schematic front view of another example of the airflow splitter 140. Finally, FIGS. 3D-3F are different cross-sectional views of the airflow splitter 140 in FIG. 3C. As noted above, the airflow splitter 140 is configured to split an inflow received from the grill 171 into a first outflow and a second outflow such that the first outflow is directed to the first cooling module 111 while the second outflow is directed to the second cooling module 112.

Referring to FIGS. 3A-3C, in some examples, the airflow splitter 140 comprises a first side duct 141, a second side duct 142, and a center portion 145 positioned between and interconnecting the first side duct 141 and the second side duct 142. The center portion 145 is aligned with grill 171 and is configured to split the inflow received from grill 171 into the first outflow and the second outflow.

Briefly, referring to FIGS. 2D and 2E, in some examples, the first side duct 141 is connected to the first cooling module 111 and is configured to direct the first outflow to the first cooling module 111. Similarly, the second side duct 142 is connected to the second cooling module 112 and is configured to direct the second outflow to the second cooling module 112. The center portion 145 may be supported on the frame vehicle frame 150, e.g., connected to the front cross-member 153 and/or the front cross-member 153. In some examples, the first side duct 141 and the second side duct 142 may not be directly connected to the center portion 145. The center portion 145 may overlap with each of the first side duct 141 and the second side duct 142 to ensure smooth airflow into each side duct. These modular and support features help with the serviceability of the electric commercial vehicle 100. For example, only the center portion 145 (but not the first side duct 141 or the second side duct 142) may need to be removed from the electric commercial vehicle 100 when accessing the first battery pack 161 and the second battery pack 162.

Referring to FIG. 3F, in some examples, the center portion 145 is configured to direct the first outflow and the second outflow away from each other along the width direction 102. For example, the volumetric flow rate of the first outflow and the second outflow may be substantially the same (i.e., to ensure a similar heat transfer rate through the first cooling module 111 and the second cooling module 112 at a given time). Different sections of the center portion 145 may be specially configured to enable this flow split and carry the outflows to the first cooling module 111 and second cooling module 112 or, more specifically, to the first side duct 141 and second side duct 142.

Referring to FIG. 3F, in some examples, each of the first side duct 141 and the second side duct 142 comprises an inlet opening 143 and an outlet opening 144. Depending on the size/shape of grill 171, the inlet openings 143 may receive the airflow from the center portion 145 and/or directly from grill 171 (which may be referred to as ram air), while the outlet opening 144 directs the airflow to the corresponding cooling module. Specifically, outlet opening 144 may be sized to the footprint of the corresponding cooling module, e.g., the size of the liquid-cooling radiator 120. In some examples, the edge of the side duct forming the outlet opening 144 is attached to the corresponding cooling module (e.g., using a set of fasteners). Furthermore, this edge may be substantially sealed to the corresponding cooling module to ensure that all airflow passes through the cooling module.

Referring to FIGS. 3D-3F, in some examples, the outlet opening 144 has a larger area than the inlet opening 143, e.g., at least 50% larger or even at least 100% larger. For example, the height (in the height direction 103) of the inlet opening 143 can be 0.4-0.6 meters, while the height of the outlet opening 144 can be 0.6-0.7 meters. In the same or other examples, the width (in the width direction 102) of the inlet opening 143 can be 0.1-0.2 meters, while the width of the outlet opening 144 can be 0.2-0.3 meters.

Referring to FIGS. 3D-3F, in some examples, the center of the inlet opening 143 is offset relative to the center of the outlet opening 144 along at least one of the width direction 102 and the height direction 103. In the same or other examples, the center of the inlet opening 143 is offset relative to the center of the outlet opening 144 along both the width direction 102 and the height direction 103. For example, the centers of the two inlet openings 143 (of the first cooling module 111 and second cooling module 112) may be positioned closer to each other than the centers of the two outlet openings 144, thereby allowing the first cooling module 111 and second cooling module 112 to be positioned outside of the vehicle frame 150, while positioning the two inlet openings 143 closer to the grill 171. Furthermore, lowering the two outlet openings 144 (relative to the two inlet openings 143) allows positioning larger radiators (in the cooling modules) without raising the contour of the vehicle body 170 (e.g., without increasing the height of the hood thereby ensuring the visibility of the electric commercial vehicle 100).

Referring to FIG. 3F, in some examples, the inlet opening 143 is not parallel to the outlet opening 144. Furthermore, each of the inlet opening 143 and the outlet opening 144 may not be parallel to a plane defined by the width direction 102 and the height direction 103. For example, the relative angle (identified as “α” in FIG. 3F) between the inlet opening 143 and the outlet opening 144 (of each side duct) may be 5°-25° or, more specifically, 10°-20°. In the same or other examples, the relative angles (identified as “β” in FIG. 3F) between the two inlet openings 143 (of the first side duct 141 and the second side duct 142) may be 140°-175°or, more specifically, 155°-165°. Furthermore, the relative angles (identified as “γ” in FIG. 3F) between the two outlet openings 144 (of the first side duct 141 and the second side duct 142) may be 110°-150° or, more specifically, 120°-140°. These features allow the positioning of larger radiators (in the cooling modules) without increasing the width of the electric commercial vehicle 100 while maintaining the cooling modules outside of the vehicle frame 150.

Referring to FIG. 3B and the “first grill intake boundary” example, the projection of each of the inlet opening 143 may not overlap with a projection of the grill 171 onto the Y-Z plane defined by the width direction 102 and the height direction 103. In this example, all ram air is first directed to the center portion 145, which then redirects this area to the inlet openings 143.

Referring to FIG. 3B and the “second grill intake boundary” example, the projection of each of the inlet opening 143 may overlap with a projection of the grill 171 onto the Y-Z plane defined by the width direction 102 and the height direction 103. For example, at least 25% (e.g., 25-40%) of each inlet opening's projection may overlap with the grill 171 or even at least 50% (e.g., 50-65%), or even at least 75% (e.g., 75-90%). These overlap values depend on the grill size, shape, location, and configuration (e.g., a single opening, multiple openings, etc.) These overlap values determine a portion of the ram air first directed to the center portion 145, which then redirects this air to the inlet openings 143. Another portion of ram air may directly enter the inlet openings 143 thereby being carried by the side ducts to the respective cooling modules. When this later portion reaches a significant value (e.g., at least 80%, at least 90%, or even at least 95% of the total ram air), the center portion 145 may be eliminated.

Referring to FIG. 3B and the “third grill intake boundary” example, the grill boundary may include/defined by two openings (or even three openings or more openings). In the illustrated example, the projection of each of the inlet opening 143 overlaps with a projection of the grill 171 onto the Y-Z plane defined by the width direction 102 and the height direction 103, e.g., full overlaps such that the inlet opening project is positioned within the grill projection 171. Alternatively, the projections may be only partially overlap, e.g., at least 25% (e.g., 25-40%) of each inlet opening's projection may overlap with the grill 171 or even at least 50% (e.g., 50-65%), or even at least 75% (e.g., 75-90%).

Referring to FIG. 3D, in some examples, the center portion 145 is non-planar and conforms around the front top cross-member 155. As a result, a portion of the center portion 145 or, more generally, a portion of the airflow splitter 140 protrudes into the frame boundary thereby reducing the overall length of the electric commercial vehicle 100. In other words, this center-portion-contouring feature allows the minimization of the distance between the front cross-member 153 and the frontmost point of the electric commercial vehicle 100 by shifting some air-routing above the vehicle frame 150.

The specific design of the cooling system 110, airflow splitter 140, and vehicle frame 150 allows servicing front battery packs (i.e., the first battery pack 161 and the second battery pack 162) without removing either one of the first cooling module 111 and the second cooling module 112 or, more specifically, without separating any fluidic connections to either the first cooling module 111 and the second cooling module 112. As noted above, in some examples (i.e., when the battery packs are liquid cooled), the fluidic connections to the first battery pack 161 and the second battery pack 162 may be severed when removing these packs.

Specifically, each of the front cross-member 153, the first battery pack 161, and the second battery pack 162 is removable from the electric commercial vehicle 100 without the removal of either the first cooling module 111 or the second cooling module 112. In more specific examples, each of the front cross-member 153, the first battery pack 161, and the second battery pack 162 is removable from the electric commercial vehicle 100 without the removal of either one of the first side duct 141 and second side duct 142.

### Examples of Cooling Module Components

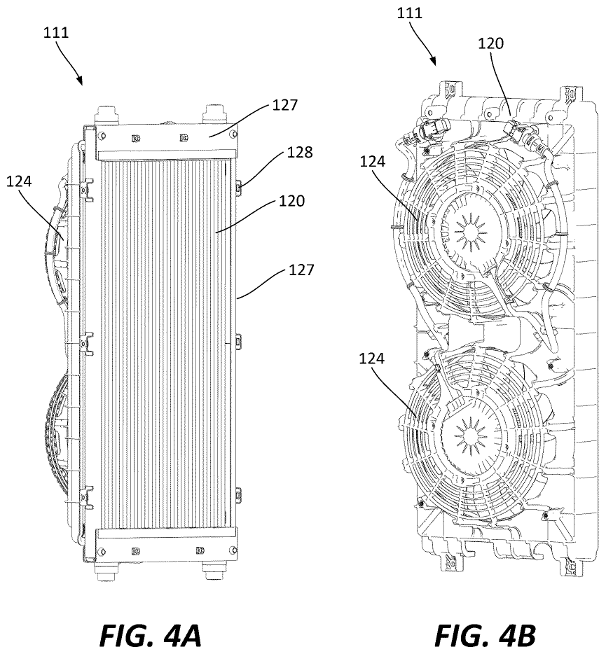

FIGS. 4A and 4B are two perspective views of the first cooling module 111, in accordance with some examples. It should be noted that the second cooling module 112 may be identical to the first cooling module 111 (with the exception of brackets used to mount the cooling module to the vehicle frame 150). As shown in FIGS. 4A and 4B, the first cooling module 111 comprises a liquid-cooling radiator 120 and a set of fans 124. These components may be attached to and supported on a cooling module frame 127, which may include a set of attachment points 128 for attaching a corresponding side duct (e.g., a first side duct 141 in which example). The cooling module frame 127 is also attached to the vehicle frame 150.

Referring to FIG. 4B, a set of fans 124 may include a single fan or two fans (as shown). The two-fan configuration allows using a liquid-cooling radiator 120 that has a height about twice greater than the width, thereby allowing a more compact packaging (in the width direction) outside the frame 150.

Referring to FIG. 4A, in some examples, a cooling module may comprise a refrigerant heat-exchanger 122 that may be positioned between the liquid-cooling radiator 120 and the set of fans 124. In a more specific example, each of the first cooling module 111 and the second cooling module 112 further comprises an electronic expansion valve 125 (not shown in FIG. 4A). The electronic expansion valve 125 may be attached to a corresponding refrigerant heat-exchanger or be a part of it.

Referring to FIG. 2C, in some examples, the liquid-cooling radiator 120 of the first cooling module 111 is fluidically connected in parallel with the liquid-cooling radiator 120 of the second cooling module 112.

Referring to FIG. 2C, in some examples, the cooling system 110 is further comprising a central thermal unit 115 fluidically connected to each of the first battery pack 161, the second battery pack 162, the liquid-cooling radiator 120 of the first cooling module 111, and the second cooling module 112. Specifically, the central thermal unit 115 is configured to control the temperature of each of the first battery pack 161, and the second battery pack 162.

In some examples, a central thermal unit 115 comprises a compressor, a three-way valve, a liquid-cooled condenser, a chiller, and a six-port valve. The liquid-cooled condenser comprises a condenser-refrigerant member and a condenser-coolant member and may be fluidically coupled to the refrigerant heat exchanger 122 of each cooling module. The chiller comprises a chiller refrigerant member and a chiller coolant member. The six-port valve comprises a battery pump inlet port, battery return port, powertrain pump inlet port, powertrain/cabin loop return port, radiator inlet port, and radiator return port. The condenser-refrigerant member and the condenser-coolant member are thermally coupled. The chiller refrigerant member and the chiller coolant member are thermally coupled. The refrigerant 3-way valve either (a) directs the compressor outlet refrigerant (vapor) to the heat exchanger inlets (refrigerant heat exchangers in parallel, e.g., during cooling modes) or (b) directs the compressor outlet refrigerant (vapor) to the liquid-cooled condenser (LCC)) (e.g., during heat pump modes). Overall, this 3-way valve directs the compressor discharge to either the heat exchanger or the LCCs depending on the selected operating mode.

### Examples of Methods of Servicing Battery Packs

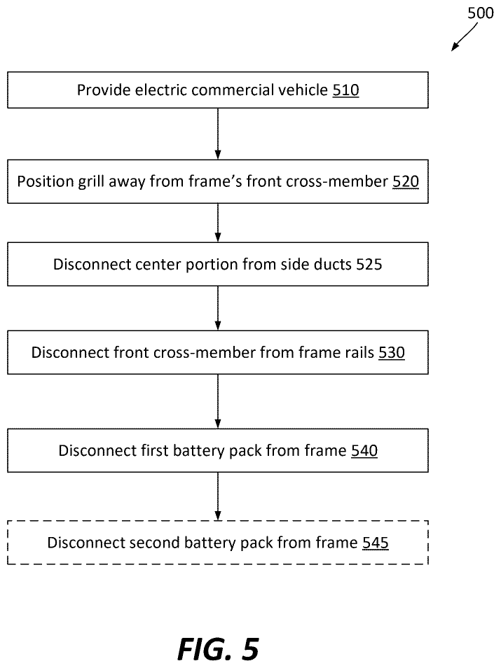

FIG. 5 is a process flowchart corresponding to method 500 of servicing battery packs on an electric commercial vehicle 100, in accordance with some examples. Method 500 may commence with (block 510) providing the electric commercial vehicle 100. Various examples of electric commercial vehicles 100 are described above. One feature of this method 500 is the ability to service the battery packs without breaking any fluidic connections to the cooling modules.

Referring to FIG. 5, in some examples, method 500 proceeds with (block 520) positioning the grill 171 away from the front cross-member 153. For example, a portion of the vehicle body 170 that houses the grill 171 may be tilted (relative to the rest of the vehicle body 170) or removed. This operation provides access to the airflow splitter 140 and vehicle frame 150.

Referring to FIG. 5, in some examples, method 500 proceeds with (block 525) disconnecting the center portion 145 from vehicle frame 150. As noted above, the airflow splitter 140 comprises a first side duct 141, a second side duct 142, and a center portion 145 positioned between the first side duct 141 and the second side duct 142. The first side duct 141 and the second side duct 142 may remain attached to the electric commercial vehicle 100, e.g., to their respective cooling modules.

Referring to FIG. 5, in some examples, method 500 proceeds with (block 530) disconnecting the front cross-member 153 from each of the first frame rail 151 and the second frame rail 152. The front cross-member 153 may be also disconnected from the first battery pack 161 during this operation, which the external support provided to the first battery pack 161. The removal of the front cross-member 153 provides access to the first battery pack 161.

Referring to FIG. 5, in some examples, method 500 proceeds with (block 540) disconnecting the first battery pack 161 from the remaining cross-member and sliding the first battery pack 161 from the open frame cavity 159 (through the opening formed by removal of the front cross-member 153). The first battery pack 161 may be fluidically decoupled from the rest of the cooling system 110 prior to removing the first battery pack 161 from the electric commercial vehicle 100. However, each of the first cooling module 111 and the second cooling module 112 remain fluidically connected to a remaining portion of the cooling system 110 while the first battery pack 161 is being removed from the electric commercial vehicle 100.

Referring to FIG. 5, in some examples, method 500 proceeds with (block 545) disconnecting the second battery pack 162 from frame 150. Specifically, this operation may involve the removal of the front top cross-member 155 (similar to the removal of the front cross-member 153), fluidically decoupling the second battery pack 162 from the rest of the cooling system 110, and sliding the second battery pack 162 through the opening formed after removing the front top cross-member 155. In some examples, the second battery pack 162 may be removed independently from the first battery pack 161, i.e., the first battery pack 161 may remain on the electric commercial vehicle 100 while the second battery pack 162 is removed or the second battery pack 162 may remain on the electric commercial vehicle 100 while the first battery pack 161 is removed. In either case, the first cooling module 111 and the second cooling module 112 remain fluidically connected to a remaining portion of the cooling system 110 while the second battery pack 162 is being removed from the electric commercial vehicle 100.

### Conclusion

Although the foregoing concepts have been described in some detail for purposes of clarity of understanding, it will be apparent that certain changes and modifications may be practiced within the scope of the appended claims. It should be noted that there are many alternative ways of implementing processes, systems, and apparatuses. Accordingly, the present embodiments are to be considered illustrative and not restrictive.

1. An electric commercial vehicle comprising:
a vehicle body comprising a grill and defining a length direction, a width direction perpendicular to the length direction, and a height direction perpendicular to each of the length direction and the width direction;
a vehicle frame comprising a first frame rail and a second frame rail extending along the length direction and forming an open frame cavity between the first frame rail and the second frame rail;
a first battery pack positioned at least in part within the open frame cavity between the first frame rail and the second frame rail;
a second battery pack stacked with the first battery pack along height direction and extending at least in part outside of the open frame cavity;
a cooling system comprising a first cooling module, a second cooling module, and an airflow splitter, wherein:
each of the vehicle frame, the first battery pack, the second battery pack extends at least in part between the first cooling module and the second cooling module, and
the airflow splitter is configured to split an inflow received from the grill into a first outflow and a second outflow such that the first outflow is directed to the first cooling module while the second outflow is directed to the second cooling module, and
each of the first cooling module and the second cooling module comprises at least a liquid-cooling radiator.

2. The electric commercial vehicle of claim 1, wherein each of the first cooling module and the second cooling module is offset relative to the grill along the width direction.

3. The electric commercial vehicle of claim 1, wherein:
the airflow splitter comprises a first side duct, a second side duct, and a center portion positioned between the first side duct and the second side duct,
the center portion is aligned with the grill and is configured to split the inflow received from the grill into the first outflow and the second outflow,
the first side duct is connected to the first cooling module and is configured to direct the first outflow to the first cooling module, and
the second side duct is connected to the second cooling module and is configured to direct the second outflow to the second cooling module.

4. The electric commercial vehicle of claim 3, wherein the center portion overlaps with each of the first side duct and the second side duct.

5. The electric commercial vehicle of claim 3, wherein each of the center portion, the first side duct, and the second side duct is independently attached to the vehicle frame.

6. The electric commercial vehicle of claim 3, wherein:
each of the first side duct and the second side duct comprises an inlet opening and an outlet opening, and
the outlet opening has a larger area than the inlet opening.

7. The electric commercial vehicle of claim 6, wherein a center of the inlet opening is offset relative to a center of the outlet opening along at least one of the width direction and the height direction.

8. The electric commercial vehicle of claim 7, wherein the center of the inlet opening is offset relative to the center of the outlet opening along both the width direction and the height direction.

9. The electric commercial vehicle of claim 6, wherein the inlet opening is not parallel to the outlet opening.

10. The electric commercial vehicle of claim 6, wherein each of the inlet opening and the outlet opening is not parallel to a plane defined by the width direction and the height direction.

11. The electric commercial vehicle of claim 6, wherein a projection of each of the inlet opening and the outlet opening does not overlap with a projection of the grill onto a plane defined by the width direction and the height direction.

12. The electric commercial vehicle of claim 3, wherein:
the vehicle frame further comprises a front cross-member, interconnecting the first frame rail and the second frame rail such that the front cross-member extends the width direction, and
the center portion is non-planar and conforms around a front top cross-member positioned above the front cross-member and supported using the first frame rail and the second frame rail.

13. The electric commercial vehicle of claim 12, wherein each of the front cross-member, the front top cross-member, the first battery pack, and the second battery pack is removable from the electric commercial vehicle without removal of either one of the first cooling module and the second cooling module.

14. The electric commercial vehicle of claim 12, wherein each of the front cross-member, the front top cross-member, the first battery pack, and the second battery pack is removable from the electric commercial vehicle without removal of either one the first side duct and second side duct.

15. The electric commercial vehicle of claim 1, wherein each of the first cooling module and the second cooling module further comprises a refrigerant heat-exchanger.

16. The electric commercial vehicle of claim 15, wherein:
the cooling system is further comprising a central thermal unit fluidically connected to each of the first battery pack, the second battery pack, the liquid-cooling radiator and the refrigerant heat-exchanger of the first cooling module, and the liquid-cooling radiator and the refrigerant heat-exchanger of the second cooling module, and
the central thermal unit is configured to control temperature of each of the first battery pack, and the second battery pack.

17. The electric commercial vehicle of claim 1, wherein each of the first cooling module and the second cooling module further comprises a set of fans offset relative to each other along the height direction.

18. The electric commercial vehicle of claim 1, wherein each of the first cooling module and the second cooling module further comprises an electronic expansion valve.

19. The electric commercial vehicle of claim 1, wherein the liquid-cooling radiator of the first cooling module is fluidically connected in parallel with the liquid-cooling radiator of the second cooling module.

20. A method of servicing an electric commercial vehicle, the method comprising:
providing the electric commercial vehicle comprising a vehicle frame, a first battery pack, and a cooling system, wherein:
the vehicle frame comprises a first frame rail, a second frame rail, a front cross-member attached to and supporting at least in part the first battery pack, and a front top cross-member attached to and supporting at least in part the second battery pack, and
the cooling system comprising a first cooling module, a second cooling module, and an airflow splitter comprising a first side duct, a second side duct, and a center portion positioned between the first side duct and the second side duct, and
each of the vehicle frame, the first battery pack, and the second battery pack extends at least in part between the first cooling module and the second cooling module;
positioning the grill away from the front cross-member;
disconnecting the center portion from the vehicle frame;
disconnecting the front cross-member from each of the first frame rail and the second frame rail; and
disconnecting the first battery pack from each of the first frame rail and the second frame rail and removing the first battery pack from the electric commercial vehicle, wherein each of the first cooling module and the second cooling module remain fluidically connected to a remaining portion of the cooling system while the first battery pack is being removed from the electric commercial vehicle.
